(19) United States
(12) Patent Application Publication
(10) Pub. No.: US 2004/0192197 A1
(43) Pub. Date: Sep. 30, 2004

(54) Geostationary satellite system with satellite clusters having intra-cluster local area networks and inter-cluster wide area network

(75) Inventors: Larry H. Capots, Mountain View, CA (US); Ronald H. Clark, Cupertino, CA (US); Terry E. Ford, Aurora, CO (US)

Correspondence Address: MCDERMOTT WILL & EMERY LLP, 18191 VON KARMAN AVE., IRVINE, CA, 92612-7107, US

(73) Assignee: Lockheed Martin Corporation, Bethesda, MD (US)

(21) Appl. No.: 10/445,727

(22) Filed: May 23, 2003

Related U.S. Application Data
(63) Continuation-in-part of application No. 09/557,919, filed on Apr. 21, 2000, now abandoned.

(51) Int. Cl. H04B 7/185; H04Q 7/20

(52) U.S. Cl. 455/12.1; 455/427; 455/445

(57) ABSTRACT

Intra-cluster and inter-cluster satellite network and communication method thereof. A satellite network includes a plurality of satellites disposed in one or a plurality of orbits, and a first wireless network formed between each of the plurality of satellites. The first wireless network includes a communication channel to transmit and receive spatial information between at least two of the plurality of satellites. Additionally, the satellite network includes a second wireless network formed between each of the plurality of satellites. The second wireless network includes a receiver, a routing system, and a transmitter.

### CROSS-REFERENCES TO RELATED APPLICATIONS

This application is a continuation-in-part application and claims priority to U.S. application Ser. No. 09/557,919 filed Apr. 21, 2000, which is incorporated by reference herein.

### BACKGROUND OF THE INVENTION

The present invention relates to a geostationary satellite communication system with clusters of communications satellites having intra-cluster local area networks and an inter-cluster wide area networks.

Satellite communications have become an important component in worldwide telecommunications. Geostationary satellites offer an important advantage in that they remain at a fixed position in the sky. As demand for satellite telecommunications has increased, the techniques used to provide additional communication bandwidth typically require additional power from the satellite platform. A problem arises in that the power that can be supplied from a single satellite platform is limited. There are limits to the amount of power that power generation means of a given size can supply. The materials, structures, and launch vehicle performance limit the size of a satellite platform and thus, the size of the power generation means. Power that is generated must be dissipated and thermal dissipation considerations limit the amount of power that can be dissipated. All of these factors combine to produce an upper limit on the amount of power that can be supplied by a single satellite platform.

The standard solution to this problem has been to place additional satellites in additional orbital slots. However, the number of geostationary orbital slots is limited, and in particular, the geographically desirable geostationary orbital slots are almost all allocated. A need arises for a technique by which power available for communications transmissions can be increased in desirable geostationary orbital slots.

### BRIEF SUMMARY OF THE INVENTION

The present invention is a satellite communication system which allows power available for communications transmissions to be cost-effectively increased, and which better utilizes the limited number of desirable geostationary orbital slots. The present invention includes a satellite system comprising a plurality of satellite clusters and a wide-area network inter-connecting the plurality of satellite clusters. Each satellite cluster is disposed in a different geostationary orbital slot and comprises a plurality of satellites, and a local area network inter-connecting the plurality of satellites.

In one embodiment of the present invention, the plurality of satellites comprises at least one satellite selected from at least one of communications satellites, remote sensing satellites, and scientific satellites. In another embodiment of the present invention, the plurality of satellites comprises at least one satellite selected from at least two of communications satellites, remote sensing satellites, and scientific satellites. In another embodiment of the present invention, the plurality of satellites comprises at least one communications satellites, at least one remote sensing satellite, and at least on scientific satellite.

In one embodiment of the present invention, the plurality of satellites comprises at least one communications satellite, which comprises a steerable antenna operable to receive a communications signal from a ground terminal; radio-frequency receiving circuitry operable to process the signal received by the antenna and decoding the signal to form communications traffic data; a data processor operable to select another satellite from among the plurality of satellites as a destination for the communications traffic data; and local-area network circuitry operable to transmit the communications traffic data to the selected satellite. The local-area network circuitry may be further operable to receive communications traffic data from another satellite; and the radio-frequency transmitting circuitry may be further operable to encode communications traffic data received by the local-area network circuitry for transmission by the antenna to a ground terminal.

In one embodiment of the present invention the plurality of satellites comprises at least one remote sensing satellite, which comprises a sensor operable to remotely sense a physical phenomenon and output a signal representing the physical phenomenon; processing circuitry operable to process the signal output from the sensor to form sensor data; a data processor operable to select another satellite from among the plurality of satellites as a destination for the sensor data; and local-area network circuitry operable to transmit the sensor data to the selected satellite. The selected satellite may be operable to transmit the sensor data to another satellite cluster or to a ground terminal.

In one embodiment of the present invention, the plurality of satellites comprises at least one scientific satellite, which comprises an experiment operable to output a signal representing results of a scientific experiment; processing circuitry operable to process the signal output from the experiment to form result data; a data processor operable to select another satellite from among the plurality of satellites as a destination for the result data; and local area network circuitry operable to transmit the result data to the selected satellite. The selected satellite may be operable to transmit the result data to another satellite cluster or to a ground terminal.

In one embodiment of the present invention, at least one of the satellite clusters comprises an inter-cluster router satellite connected to the local-area network and to the wide-area network. The inter-cluster router satellite may comprise wide-area network circuitry operable to receive communications traffic data from another satellite cluster, the communications traffic data destined for a communications satellite in the same satellite cluster as the inter-cluster router satellite; and local area network circuitry operable to transmit the received communications traffic data to the communications satellite for which the communications traffic data is destined. The local-area network circuitry may be further operable to receive communications traffic data from another communications satellite in the same satellite cluster as the inter-cluster router satellite, the communications traffic destined for a communications satellite in a different satellite cluster from the inter-cluster router satellite; and the wide-area network circuitry may be further operable to transmit the received communications traffic data to the satellite cluster including the communications satellite for which the communications traffic is destined.

In one embodiment of the present invention, at least one of the satellite clusters comprises a communications/inter-cluster router combination satellite connected to the local-area network and to the wide-area network. The communications/inter-cluster router satellite may comprise a steerable antenna operable to receive a communications signal from a ground terminal; radio-frequency receiving circuitry operable to process the signal received by the antenna and decoding the signal to form communications traffic data; a data processor operable to select another communications satellite from among the plurality of communications satellites in the same satellite cluster as the communications/inter-cluster router satellite or in a different satellite cluster as a destination for the communications traffic data; local-area network circuitry operable to transmit the received communications traffic data to the selected communications satellite, if the selected communications satellite is in the same satellite cluster as the communications/inter-cluster router satellite; and wide-area network circuitry operable to transmit the received communications traffic data to the satellite cluster including the communications satellite for which the communications traffic is destined, if the selected communications satellite is in a different satellite cluster than the communications/inter-cluster router satellite. The wide-area network circuitry may be further operable to receive communications traffic data from another satellite cluster, the communications traffic data destined for a communications satellite in the same satellite cluster as the inter-cluster router satellite; and local-area network circuitry may be further operable to transmit the received communications traffic data to the communications satellite for which the communications traffic data is destined.

In one embodiment of the present invention, at least one of the satellite clusters comprises a cluster utility satellite operable to receive command data from a ground terminal and transmitting the command data to the plurality of satellites. The cluster utility satellite may comprise a power generator; and power distribution circuitry operable to transmit power to the plurality of satellites.

In another embodiment of the present invention, a satellite network includes a plurality of satellites disposed in one or a plurality of orbits, and a first wireless network formed between each of the plurality of satellites. The first wireless network includes a communication channel to transmit and receive spatial information between at least two of the plurality of satellites. Each of the plurality of satellites includes spatial information indicative of a position and an orientation of the each of the plurality of satellites. Additionally, the satellite network includes a second wireless network formed between each of the plurality of satellites. The second wireless network includes a receiver to receive an information packet including data and routing information at a first satellite. The routing information includes at least a destination satellite as a destination of the data. Moreover, the second wireless network includes a routing system to determine a desired route from a plurality of routes to transmit the data from the first satellite to the destination satellite based on at least the spatial information of the plurality of satellites. The plurality of routes correspond to a plurality of paths respectively, and each of the plurality of paths include a plurality of path satellites. Each of the plurality of path satellites includes the first satellite and the destination satellite or includes the first satellite, the destination satellite, and at least one of the other satellites of the plurality of satellites. Also, the second wireless network a transmitter to transmit the data based upon the desired route and the spatial information of the plurality of path satellites of the desired route. The spatial information of the plurality of path satellites of the desired route provides for transferring the data from the first satellite to the destination satellite.

In yet another embodiment of the present invention, a satellite network includes a plurality of satellites disposed in a single slot of a geostationary orbit, and a wireless local area network formed between each of the plurality of satellites. The wireless local area network includes a communication channel to transmit and receive spatial information between at least two of the plurality of satellites, the spatial information indicative of a position and an orientation of the each of the plurality of satellites. Additionally, the wireless local area network includes a receiver to receive a communication signal including data and routing information at a first satellite. The routing information includes at least a destination satellite as a destination of the data. Moreover, the wireless local area network includes a routing system to determine a desired route from a plurality of routes to transmit the data from the first satellite to the destination satellite. Each of the plurality of routes corresponds to a plurality of path satellites, and each of the plurality of path satellites includes the first satellite and the destination satellite or includes the first satellite, the destination satellite, and at least one of the other satellites of the plurality of satellites. Also, the wireless local area network includes a transmitter to transmit the data based upon the desired route and the spatial information of the plurality of path satellites of the desired route.

In yet another embodiment of the present invention, a satellite network includes a plurality of satellites clusters. Each of the plurality of satellite clusters is disposed in a different geostationary orbital slot. Additionally, the satellite network includes a wireless wide area network formed between each of the plurality of satellite clusters. The wireless wide area network includes a communication channel to transmit and receive spatial information between at least two of the plurality of satellite clusters, the spatial information indicative of a position and an orientation of the each of the plurality of satellite clusters. Moreover, the wireless wide area network includes a receiver to receive a communication signal including data and routing information at a first satellite cluster. The routing information includes at least a destination satellite cluster as a destination of the data. Additionally, the wireless wide area network includes a routing system to determine a desired route from a plurality of routes to transmit the data from the first satellite cluster to the destination satellite cluster. Each of the plurality of routes corresponds to a plurality of path satellite cluster, and each of the plurality of path satellite cluster includes the first satellite cluster and the destination satellite cluster or includes the first satellite cluster, the destination satellite cluster, and at least one of the other satellite cluster of the plurality of satellite cluster. Also, the wireless wide area network includes a transmitter to transmit the data based upon the desired route and the spatial information of the plurality of path satellite clusters of the desired route.

In yet another embodiment of the present invention, a method for satellite communication includes disposing a plurality of satellites in one or a plurality of orbits, and transmitting and receiving spatial information between at least two of the plurality of satellites. Each of the plurality of satellites includes spatial information indicative of a position and an orientation of the each of the plurality of satellites. Additionally, the method includes receiving an information packet including data and routing information at a first satellite, the routing information including at least a destination satellite as a destination of the data. Moreover, the method includes determining a desired route from a plurality of routes to transmit the data from the first satellite to the destination satellite based on at least the spatial information of the plurality of satellites. The plurality of routes corresponding to a plurality of paths respectively. Each of the plurality of paths includes a plurality of path satellites, and each of the plurality of path satellites includes the first satellite and the destination satellite or includes the first satellite, the destination satellite, and at least one of the other satellites of the plurality of satellites. Also, the method includes transmitting the data based upon the desired route and the spatial information of the plurality of path satellites of the desired route. The spatial information of the plurality of path satellites of the desired route provides for transferring the data from the first satellite to the destination satellite.

Many benefits may be achieved by way of the present invention over conventional techniques. For example, certain embodiments of the present invention provides a wireless LAN, a wireless WAN, or both. The wireless LAN, the wireless WAN, or both can intelligently route the communication signal through one or several desirable routes towards its final destination. The determination of the desirable routes takes into account various factors, such as route cost, route distance, route availability, route traffic load, and signal priority. In some embodiments of the present invention, each base station of a wireless LAN, a wireless WAN, or both can route the communication signal to multiple base stations depending upon the routing decision made at a given time for a given communication signal. The communication signal between network base stations and users carries various information, and is not limited to standard messages such as one of time, position, or velocity.

Depending upon the embodiment under consideration, one or more of these benefits may be achieved. These and other benefits as applied to embodiments of the present invention are provided throughout the present specification and more particularly below.

These benefits and various additional objects, features and advantages of the present invention can be fully appreciated with reference to the detailed description and accompanying drawings that follow.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is a diagram of prior art satellites in geostationary orbit above the Earth.

FIG. 2a is an exemplary block diagram of a homogeneous embodiment of a geostationary satellite cluster, according to the present invention.

FIG. 2b is another exemplary block diagram of the homogeneous geostationary satellite cluster shown in FIG. 2a.

FIG. 2c is an exemplary block diagram of inter-satellite communications in the geostationary satellite cluster shown in FIG. 2a.

FIG. 3 is an exemplary block diagram of a heterogeneous embodiment of a geostationary satellite cluster, according to the present invention.

FIG. 4 is an exemplary block diagram of an intra cluster local-area network (LAN) implemented in the geostationary satellite clusters shown in FIG. 3.

FIG. 4a is a simplified diagram for LAN interconnect segment according to an embodiment of the present invention.

FIG. 4b is a simplified diagram showing network structure of LAN according to an embodiment of the present invention.

FIG. 4c is a simplified diagram for communication routes according to one embodiment of the present invention.

FIG. 4d is a simplified diagram of intra-cluster routing database for data processing segment according to one embodiment of the present invention.

FIG. 5 is an exemplary block diagram of a worldwide geostationary satellite cluster system, according to the present invention.

FIG. 6 is one embodiment of a satellite cluster shown in FIG. 5.

FIG. 6a is a simplified diagram for WAN interconnect segment according to an embodiment of the present invention.

FIG. 6b is a simplified diagram showing network structure of WAN according to an embodiment of the present invention.

FIG. 6c is a simplified diagram for communication routes according to one embodiment of the present invention.

FIG. 6d is a simplified diagram of inter-cluster routing database for data communications according to one embodiment of the present invention.

FIG. 7 is another embodiment of a satellite cluster shown in FIG. 5.

FIG. 8 is another embodiment of a satellite cluster shown in FIG. 5.

### DETAILED DESCRIPTION OF THE INVENTION

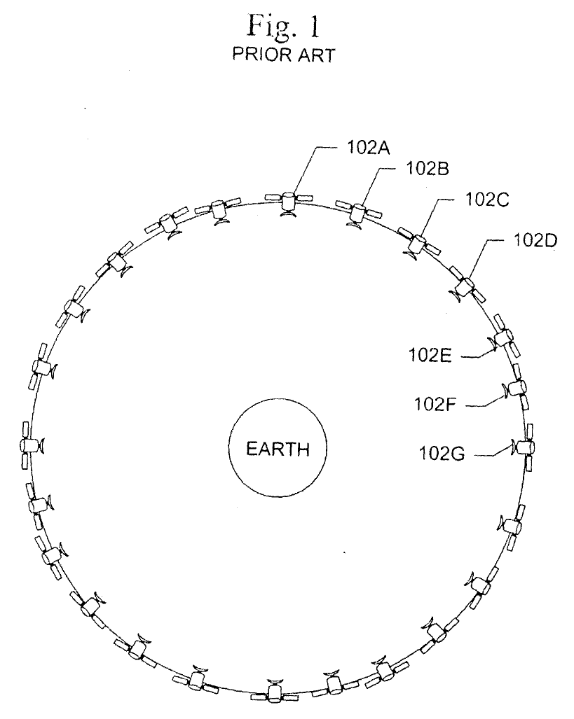

Satellites in geostationary orbit above the Earth are shown in FIG. 1. A geostationary orbit is an equatorial orbit having the same angular velocity as that of the Earth, so that the position of a satellite in such an orbit is fixed with respect to the Earth. Geostationary orbit is achieved at a distance of approximately 22,236 miles above the Earth. Satellites operating on the same frequency band must be spatially separated to avoid interference due to divergence of the signal transmitted from the ground. The separation between orbital slots is typically expressed in terms of the angular separation of the slots. While many factors affect the separation that is necessary, the standard separation enforced by international regulatory bodies is 2 degrees of arc. Since geostationary orbit requires an equatorial orbit, all geostationary orbital slots lie in the same plane. Thus, the number of geostationary orbital slots is limited. As shown in FIG. 1, satellites 102A-G are disposed in different orbital slots in geostationary orbit. With a required separation of 2 degrees of arc, there are only 180 geostationary orbital slots available. The situation is exacerbated by the fact that some of the orbital slots are more desirable than others. For example, orbital slots serving populated landmasses are more desirable than orbital slots serving unpopulated land areas or the oceans.

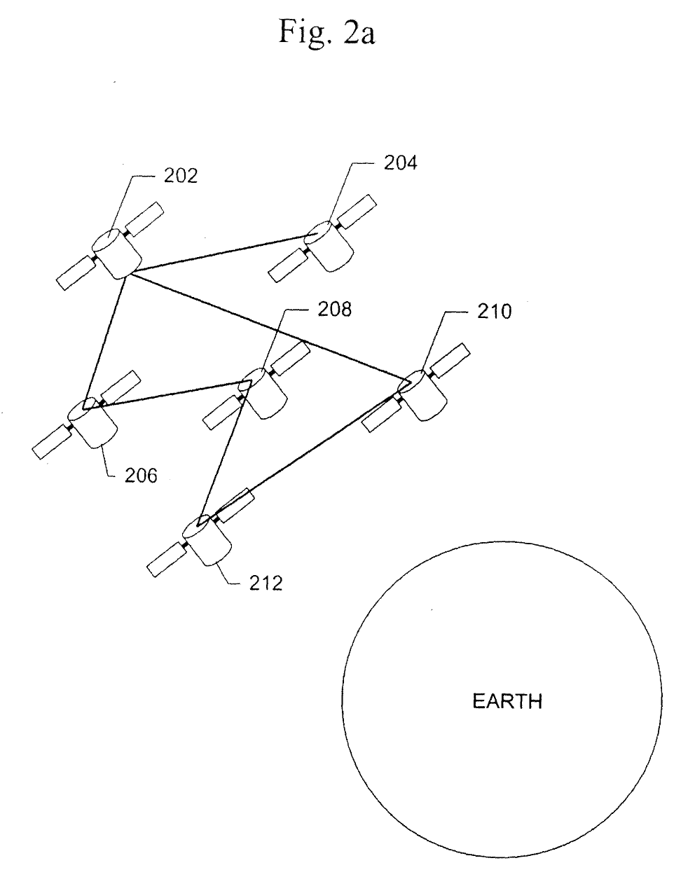

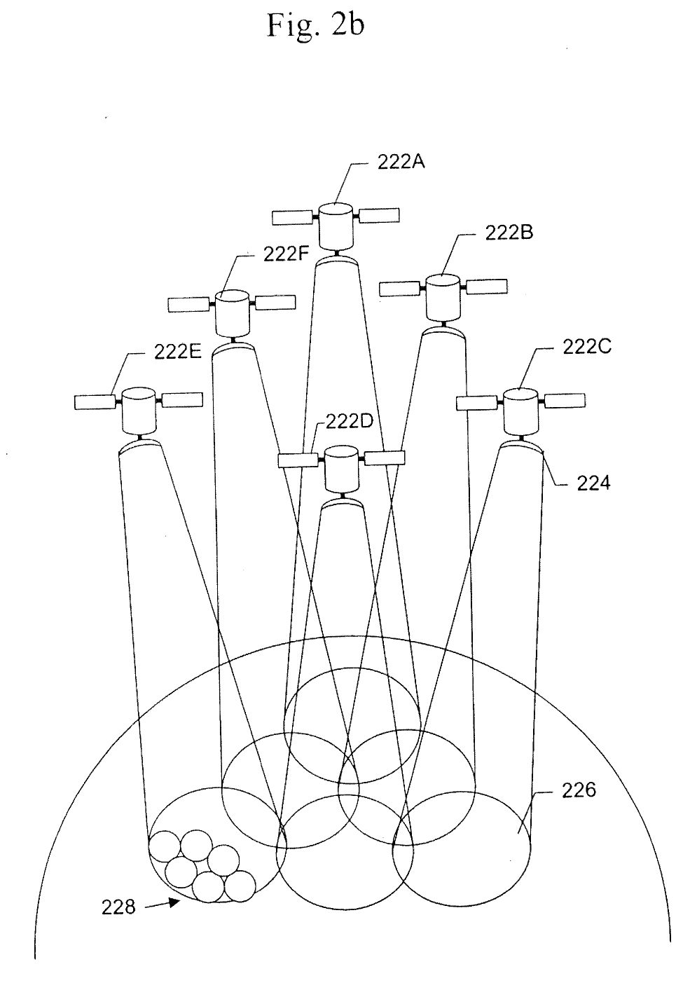

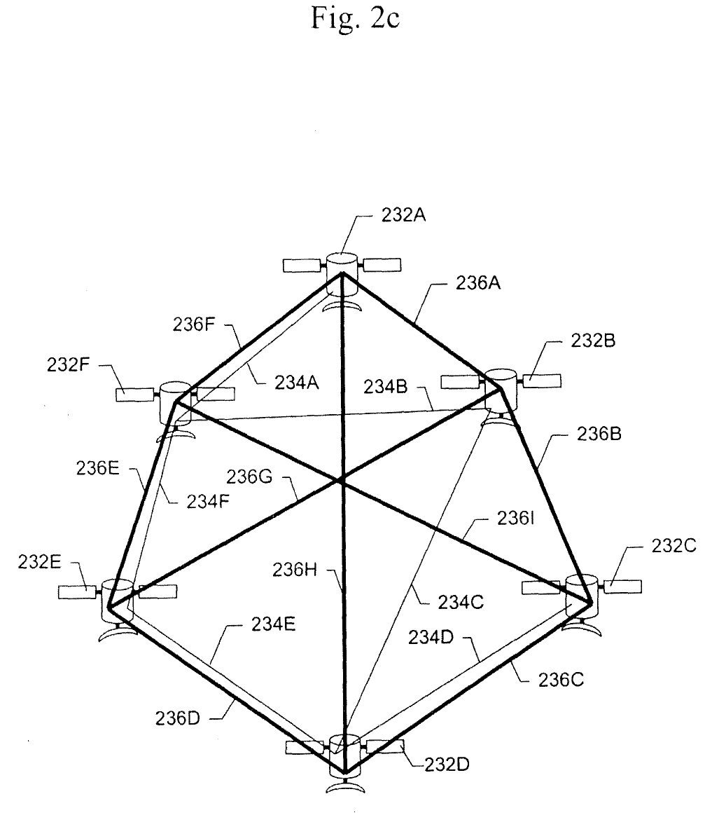

An exemplary block diagram of a homogeneous embodiment of a geostationary satellite cluster, according to the present invention, is shown in FIG. 2a. In this embodiment, cluster satellites 202-212 are homogeneous; that is, all satellites perform similar functions in the cluster. The functions performed by each cluster satellite include broadband telecommunications relay and communications with other satellites in the cluster. This embodiment allows N cluster satellites to cover N terrestrial communications zones, as shown more clearly in FIG. 2b. Each cluster satellite 222A-F has a steerable antenna system, which allows each satellite to cover one or more different terrestrial zones, even though all satellites are in the same orbital slot. A steerable antenna system must include at least one steerable antenna, but may include a plurality of steerable antennas. Each steerable antenna may provide coverage of a different terrestrial zone. Each steerable antenna may further subdivide each terrestrial zone into a plurality of smaller zones, such as sub-zones 228.

For example, cluster satellite 222C includes steerable antenna system 224, which allows coverage of terrestrial zone 226. For clarity, each cluster satellite 222A-F is shown as covering only one terrestrial zone. However, antenna systems may be provided which provide coverage of more than one terrestrial zone per satellite. Typically, the zones covered by satellites in a satellite cluster overlap, as shown in FIG. 2b, to provide gapless coverage. However, since the antenna systems are steerable, other coverage patterns are possible. For example, if the traffic in one terrestrial zone exceeds the capacity of one cluster satellite, one or more additional cluster satellites may be used to cover that same terrestrial zone. Furthermore, the steerable antenna system allows zone coverage to be changed dynamically in response to usage and other needs. For example, traffic patterns may require temporary additional capacity in certain terrestrial zones. Likewise, if a cluster satellite should fail, the coverage zones of one or more other cluster satellites may be adjusted to provide backup coverage for the zone previously covered by the failed cluster satellite.

In this embodiment, current satellite products may be used with only minor modifications. Furthermore, it should be possible to realize cost savings from economies of scale if the same or similar hardware platforms are utilized for the satellites in a cluster. As described above, the cluster satellites should have steerable antenna systems. Many current satellite products already incorporate steerable antenna systems. Due to the relatively small spatial separation among satellites, it is preferred that each cluster satellite incorporate autonomous station keeping.

Preferably, inter-satellite communications is provided by crosslinks among the satellites 232A-F, as shown in FIG. 2c. The crosslink arrangement shown in FIG. 2c is only an example and, for clarity, only a subset of the crosslinks that may actually be used are shown. Two types of crosslinks may be used: ranging crosslinks and channel routing crosslinks. Ranging crosslinks, such as crosslinks 234A-F, are low bandwidth radio frequency (RF) or optical/laser links that allow satellites in a cluster to determine their range and angular separation from one another. This information is used to provide station keeping and to ensure satisfactory spatial separation of the satellites in the cluster. However, each cluster satellite should have at least two, and preferably more than two, ranging crosslinks in order to adequately determine its position in the cluster.

Channel routing crosslinks, such as crosslinks 236A-I, are high bandwidth RF or optical crosslinks that provide inter satellite routing of the communications traffic handled by the cluster. It is also possible that the communications and ranging functions may be combined into a single type of crosslink. Intra-cluster, inter-satellite communications routing is implemented in a local-area network (LAN) environment, as described below.

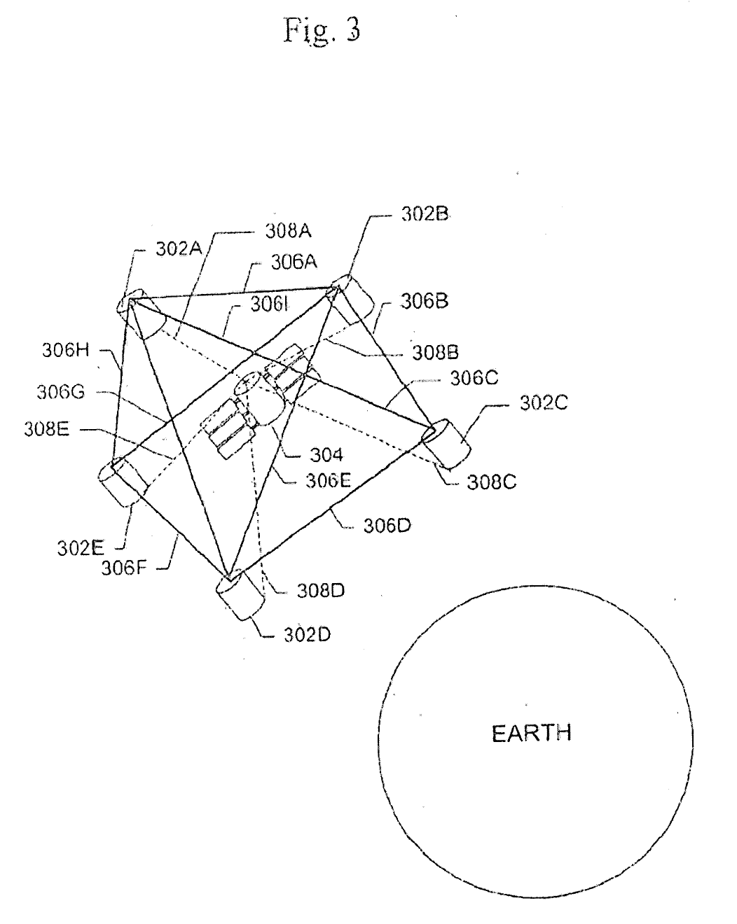

An exemplary block diagram of a heterogeneous embodiment of a geostationary satellite cluster, according to the present invention, is shown in FIG. 3. In this embodiment, the satellites 302A-E are homogeneous and perform broadband telecommunications relay and communications with other satellites in the cluster. However satellite 304, the cluster utility satellite, is not similar to the other satellites in the cluster. Cluster utility satellite 304 may include power generation and distribution equipment and a ground link for telemetry and command data for the cluster. The satellites in the heterogeneous cluster need not be the same as the satellites in the homogeneous cluster because the cluster utility satellite performs some functions, such as power generation and ground telemetry and command, for the satellites in the heterogeneous cluster that the satellites in the homogeneous cluster must perform for themselves. Thus, the satellites in the heterogeneous cluster need not include power generation and ground telemetry and command functions. Each cluster satellite 302A-E has a steerable antenna system, which allows each satellite to cover one or more different terrestrial zones, even though all satellites are in the same orbital slot. A steerable antenna system includes at least one steerable antenna, but may include a plurality of steerable antennas. Each steerable antenna may provide coverage of a different terrestrial zone.

Preferably, inter-satellite communications is provided by crosslinks among the cluster satellites 302A-E and cluster utility satellite 304. The crosslink arrangement shown in FIG. 3 is only an example and, for clarity, only a subset of the crosslinks that may actually be used are shown. Four types of crosslinks may be used: ranging crosslinks, cluster command and control crosslinks, power distribution crosslinks, and channel routing crosslinks. The ranging crosslinks and channel routing crosslinks are represented in FIG. 3 by crosslinks 306A-I, each of which links two of satellites 302A-E. The cluster command and control crosslinks and power distribution crosslinks are represented in FIG. 3 by crosslinks 308A-E, each of which links one satellite 302A-F with cluster utility satellite 304. Ranging crosslinks are radio frequency (RF) or optical/laser links that allow satellites in a cluster to determine their range from one another. This information is used to provide station keeping and to ensure satisfactory spatial separation of the satellites in the cluster. However, each cluster satellite should have at least two, and preferably more than two, ranging crosslinks in order to adequately determine its position in the cluster.

Channel routing crosslinks are high bandwidth RF or optical crosslinks that provide inter-satellite routing of the communications traffic handled by the cluster. Intra-cluster, inter-satellite communications routing is implemented in a local area network (LAN) environment, as described below.

Cluster command and control crosslinks are low bandwidth RF or optical crosslinks that communicate commands received from the ground by cluster utility satellite 304 to the appropriate cluster satellite. The command and control crosslinks are also used by cluster utility satellite 304 to control the satellites in the cluster. For example, if cluster utility satellite 304 performs the station keeping function for the cluster, cluster utility satellite 304 may communicate the appropriate commands to the cluster satellites 302A-E over the command and control crosslinks. Likewise, the command and control crosslinks may be used to communicate telemetry data from the cluster satellites 302A-F to cluster utility satellite 304, which may process the telemetry data itself, or which may transmit the telemetry data to the ground.

Power distribution crosslinks are low bandwidth, high power, RF or optical crosslinks that transmit power from cluster utility satellite 304 to each of the cluster satellites 302A-F.

It is important to note that the feature that distinguishes a homogeneous satellite cluster from a heterogeneous satellite cluster is that the heterogeneous satellite cluster includes a cluster utility satellite, while the homogeneous cluster does not. The satellites in a homogeneous cluster need not all be the same hardware platform, they need only perform similar functions in the cluster and not rely on a cluster utility satellite in order to perform their missions. Both homogeneous and heterogeneous clusters may have members that perform exactly the same mission or a mixture of missions. For example, in a homogeneous cluster, all satellites may be communications satellites, all satellites may be remote sensing satellites, all satellites may be scientific satellites, there may be a mixture of communications satellites, remote sensing satellites, and/or scientific satellites, or there may be individual satellites which combine communications, remote sensing, and/or scientific missions. The distinguishing feature of a homogeneous cluster is that no cluster utility satellite is needed for the satellites in the cluster to perform their missions. Likewise, in a heterogeneous cluster, there is a cluster utility satellite along with other satellites, which may be all communications satellites, all remote sensing satellites, all scientific satellites, a mixture of communications satellites, remote sensing satellites, and/or scientific satellites, or there may be individual satellites which combine communications, remote sensing and/or scientific missions. The distinguishing feature of a heterogeneous cluster is that a cluster utility satellite is needed for the satellites in the cluster to perform their missions.

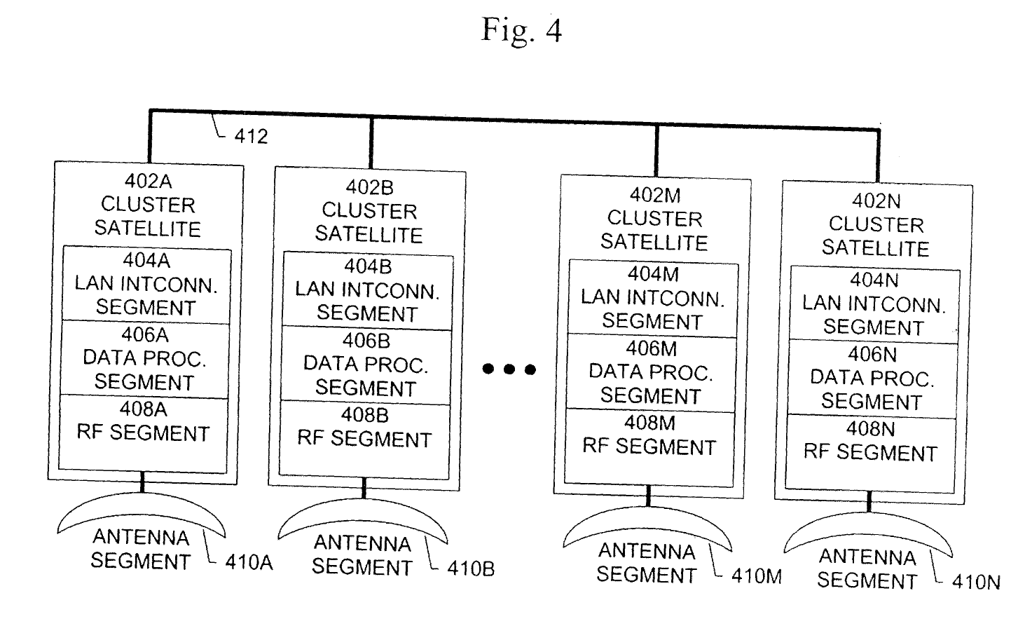

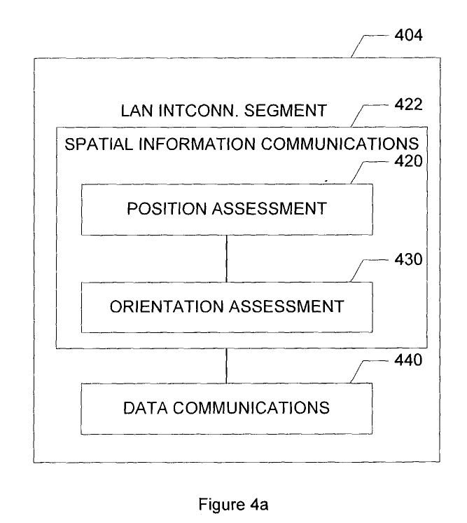

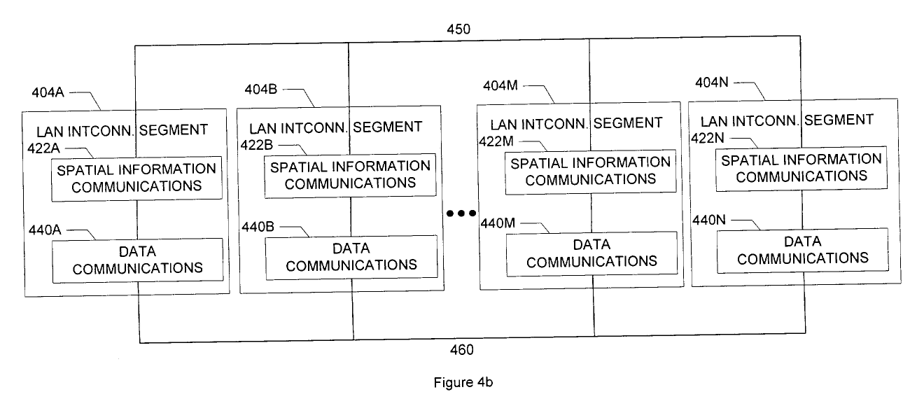

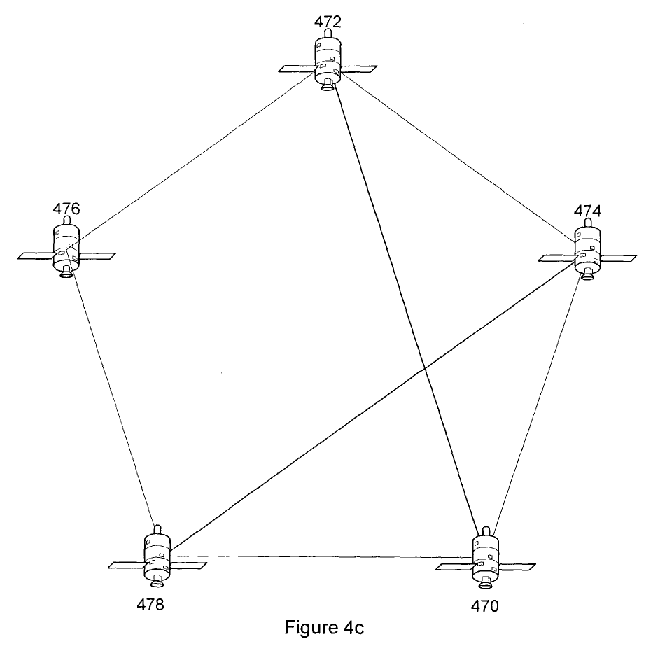

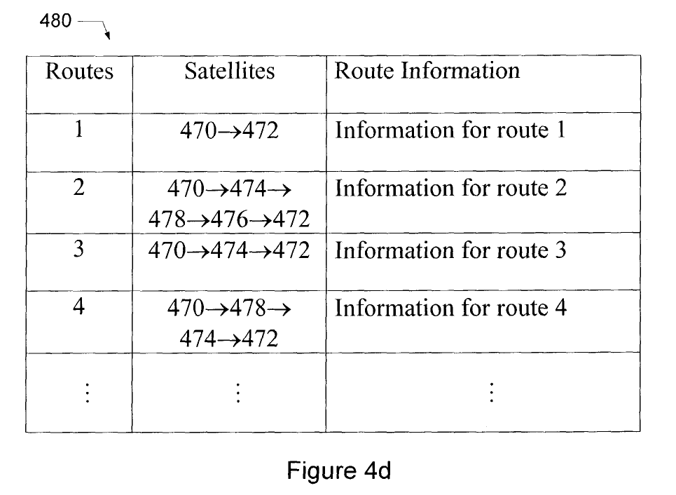

An exemplary block diagram of an intra cluster local area network (LAN) is shown in FIG. 4. The example shown in FIG. 4 is typically implemented in a homogeneous satellite cluster, but may also be implemented in a heterogeneous satellite cluster. A cluster includes a plurality of satellites, such as satellites 402A-N. Each satellite, such as satellite 402A, includes a LAN interconnect segment 404A, a data processing segment 406A, an RF segment 408A, and an antenna segment 410A. Antenna segment 410A receives communications signals from ground terminals within the antenna's terrestrial coverage zone and transmits signals to such ground terminals. RF segment 408A processes the signals received by antenna segment 410A and decodes the signal to provide communications traffic data packets. RF segment 408A also encodes communications traffic for transmission by antenna segment 410A. Data processing segment 406A processes the communications traffic and determines the proper routing for each packet of communications traffic data. LAN interconnect segment 404A implements a wireless LAN, which provides the satellite with the functionality to communicate over the intra-cluster LAN 412.

Under some circumstances a satellite may route communications traffic within the satellite itself, as is well known. For example, this may occur when there are multiple ground terminals in communication with the satellite and communications traffic is directed from one such ground terminal to another. The multiple ground terminals may all be within the same terrestrial coverage zone and communicating either on the same RF band or on different RF bands. The ground terminals may be in different terrestrial coverage zones or sub-zones if the satellite has the capability to cover more than one terrestrial zone or sub-zone.

However, the present invention provides the capability to route communications traffic among satellites. For example, this may occur when communication traffic is directed from a ground terminal in a terrestrial coverage zone covered by one satellite to a ground terminal in a terrestrial coverage zone covered by another satellite in the same cluster. In this case, communications traffic is routed from one satellite to another over the intra-cluster LAN 412. Preferably, the intra-cluster LAN is implemented as an RF or optical crosslink with a data bandwidth of about 4 gigabit per second (gbps). The intra-cluster LAN crosslink is preferably a relatively low powered link, with a range limited to about 200 kilometers (km). This range is sufficient to obtain satisfactory communications quality among satellites in the cluster, yet will avoid interference with satellites in other orbital slots. If necessary, multiple LANs may be provided, in order to increase the intra cluster data bandwidth. Multiple LANs may be implemented by using multiple RF or optical frequencies, or if the directivity is sufficient, multiple beams on the same frequency.

As shown in FIG. 4, the intra-cluster LAN 412 includes cluster satellites 402A, 402B, . . . , 402M, and 402N. These satellites serve as base stations for the intra-cluster LAN 412 and provide network coverage within the cluster in the space. The distance between these satellites varies. For example, the distance may equal to about 64 km. These cluster satellites perform networking functions such as relay, control, and logic functions. The relay function includes receiving, amplifying, and transmitting communication signals, but these cluster satellites are more powerful than simple relay satellites. The cluster satellites perform control and logic functions, such as switching, routing, channel assignment, and quality service. The routing process usually involves determination of next network point to which a received communication signal should be forwarded toward its final destination. For instance, the routing process determines the desired route for a given communication signal. For the intra-cluster LAN 412, the next network point is for example a cluster satellite, and the final destination is for example also a cluster satellite. The routing process can also involve determining timing for transmitting a received signal and delays of the received signal and the transmitted signal.

Moreover, the cluster satellites 402A, 402B, . . . , 402M, and 402N are not only bases stations but also users of the intra-cluster LAN 412. These user satellites request information from each other through the intra-cluster LAN 412, and use received information to perform various satellite functions.

As shown in FIG. 4, the intra-cluster LAN 412 carries communication signals at various data rates. For example, the data rate can be as high as 4 gbps. Additionally, the intra-cluster LAN 412 includes base stations, i.e., cluster satellites, at various distances. For example, a base station may be 200 km away from its nearest base station. Moreover, the cluster satellites move with respect to each other. The movement includes change in position, change in orientation, or both, and this movement usually requires that the intra-cluster LAN 412 have navigation capabilities. For example, a base station of the LAN 412, i.e., a cluster satellite, can seek and obtain spatial information of other base stations. The spatial information includes positions and orientations of other cluster satellites with respect to the base station.

FIG. 4a is a simplified diagram for LAN interconnect segment according to one embodiment of the present invention. This diagram is merely an illustration, which should not unduly limit the scope of the claims. One of ordinary skill in the art would recognize many variations, alternatives, and modifications. The LAN interconnect segment 404 is any one of LAN interconnect segments 404A, 404B, . . . , 404M, and 404N. As shown in FIG. 4a, the LAN interconnect 404 includes a system 422 for spatial information communications and a system 440 for data communications. The system 422 for spatial information communications includes a position assessment system 420 and an orientation assessment system 430. Although the above has been shown using systems 422, 420, 430, and 440, there can be many alternatives, modifications, and variations. For example, some of the systems may be expanded and/or combined. The position assessment system 420 and the orientation assessment system 430 may be combined. Other systems may be inserted to those noted above. Depending upon the embodiment, the specific systems may be replaced. Further details of these systems are found throughout the present specification and more particularly below.

The system 422 for spatial information communications transmits and receives spatial information for the cluster satellites 402A, 402B, . . . , 402M, and 402N. Also the system 422 sends the obtained spatial information to the system 440 for data communications. More specifically, the position assessment system 420 transmits and receives position information for the cluster satellites. Orientation assessment system 430 transmits and receives orientation information for the cluster satellites. The obtained position and orientation information can help the system 440 for data communications orientate its transmitter and receiver. The system 440 for data communications on the base station sends communication signals. Similarly, the system 440 for data communications on another cluster satellite receives the communication signals from the base station. As discussed above, the cluster satellite can serve as a base station, a user, or both.

The navigation capability as embodied in the system 422 for spatial information communications is important for the intra-cluster LAN 412. For example, the intra-cluster network 412 has the capability to perform high-speed communications over large distance. Such long-distance communications usually utilize transmitters with significant transmission power. But high-power transmitters are usually heavy. The cluster satellites 402A, 402B, . . . , 402M and 402N however usually have limited energy resources and significant weight limitations. To reduce energy consumption and transmitter weight, the base stations in the intra-cluster LAN 412 usually direct their communication signals to other base stations or user satellites, as opposed to sending out the signals into all directions. The directional transmission usually involves obtaining navigation information and aligning transmitters and receivers. The wireless connection between two cluster satellites may take various forms, such as RF connection and optical connection including laser.

FIG. 4b is a simplified diagram showing network structure of LAN according to an embodiment of the present invention. This diagram is merely an illustration, which should not unduly limit the scope of the claims. One of ordinary skill in the art would recognize many variations, alternatives, and modifications. The intra-cluster LAN 412 includes two wireless network, i.e., a wireless network 450 for spatial information communications and a wireless network 460 for data communications. These two wireless networks may operate as a single wireless network or as two separate wireless networks. The wireless networks 450 and 460 are formed respectively between each of the cluster satellites 402A, 402B, . . . , 402M and 402N as shown in FIG. 4. The wireless network 450 for spatial information communications includes at least a communication channel to transmit and receive spatial information between at least two of the cluster satellites 402A, 402B, . . . , 402M and 402N. As shown in FIG. 4b, the wireless network 450 uses systems 422A, 422B, . . . , 422M and 422N for spatial information communications. These systems for spatial information communications are respectively parts of the LAN interconnect segments 404A, 404B, . . . , 404M and 404N, as described in FIG. 4a. These interconnect segments correspond to the cluster satellites 402A, 402B, . . . , 402M and 402N respectively. Each of these cluster satellites has spatial information indicative of position and orientation of each of these satellites respectively. The wireless network 460 for date communications uses systems 440A, 440B, . . . 440M and 440N for data communications. These systems for data communications are respectively parts of the LAN interconnect segments 404A, 404B, . . . , 404M and 404N, as shown in FIG. 4a. These interconnect segments correspond to the cluster satellites 402A, 402B, . . . , 402M and 402N respectively. The systems 440A, 440B, . . . , 440M and 440N for data communications each have a receiver to receive information packets including data and routing information. The routing information provides at least information for a destination satellite as a destination of the data. For example, the routing information is stored in the headers of information packets. Data processing segments 406A, 406B, . . . , 406M, 406N each serve as a routing system to determine a desire route from a group of routes to transmit the data from the satellite receiving the information packets to the destination satellite based on at least the spatial information of cluster satellites 402A, 402B, . . . , 402M and 402N. Each route includes a group of path satellites comprising the receiving satellite and the destination satellite or comprising the receiving satellite, the destination satellite, and at least one of the other satellites of cluster satellites 402A, 402B, . . . , 402M and 402N. Additionally, the systems 440A, 440B, . . . , 440M and 440N for data communications each provide a transmitter to transmit the data based upon the desired route and the spatial information of the path satellites of the desired route. The spatial information of the path satellites of the desired route provides for transferring the data from the receiving satellite to the destination satellite. The receiving satellite, the destination satellite and other path satellites are usually selected from the cluster satellites 402A, 402B, . . . , 402M, and 402N.

Additionally, the data processing segments 406A, 406B, . . . , 406M, and 406N at a later time step receive updated spatial information of cluster satellites 402A, 402B, . . . , 402M and 402N. In response, these data processing segments determine a updated desired route based on at least the updated spatial information of the cluster satellites. The updated desired route and the pre-update desired route may be the same route or different routes. The transmitters of the systems 440A, 440B, . . . , 440M and 440N for data communications transmit the data based upon the updated desired route and the updated spatial information of the path satellites of the updated desired route. The updated spatial information of the path satellites provides for transferring the data from the receiving satellite to the destination satellite.

FIG. 4c is a simplified diagram for communication routes according to one embodiment of the present invention. This diagram is merely an illustration, which should not unduly limit the scope of the claims. One of ordinary skill in the art would recognize many variations, alternatives, and modifications. Satellites 470, 472, 474, 476 and 478 are examples of cluster satellites 402A, 402B, . . . , 402M and 402N. For example, the satellite 470 is a receiving satellite that receives a data packet, and the data packet identifies the satellite 472 as its destination satellite. From the satellite 470 to the satellite 472, there exist multiple paths corresponding to different groups of path satellites. For example, a route may take a direct path from the satellite 470 to the satellite 472. Alternatively, a route may take an indirect path from the satellite 470 to the satellite 472. For example, the route passes the satellites 470, 474, 478, 476 and 472, satellites 470, 474, and 472, satellites 470, 478, 474, and 472, or any other group of path satellites.

FIG. 4d is a simplified diagram of intra-cluster routing database for data processing segment according to one embodiment of the present invention. This diagram is merely an illustration, which should not unduly limit the scope of the claims. One of ordinary skill in the art would recognize many variations, alternatives, and modifications. The data processing segments 406A, 406B, . . . , 406M, 406N each have a routing database 480. For example, the routing database 480 for the satellite 470 includes a lists of routes from the satellite 470 to different destinations such as the satellite 472 and other satellites. As illustrated in FIG. 4d, various routes correspond to different groups of path satellites. For instance, route 2 starts from the satellite 470, passes through the satellites 474, 478, and 476, and arrives at the satellites 472. Hence the satellites 470, 474, 478, 476, and 472 are the path satellites for route 2. Additionally, routing database 480 also contains route information corresponding to each route and uses such information to select a desired route.

In a typical embodiment used for commercial telecommunications, three to five satellites would be used in one cluster. Each satellite in the cluster would have a 125 megahertz (MHz) frequency allocation, which would provide a data bandwidth of about 2 gbps. In another embodiment for military use, the satellites would use the military KA band and would include anti-jamming capabilities.

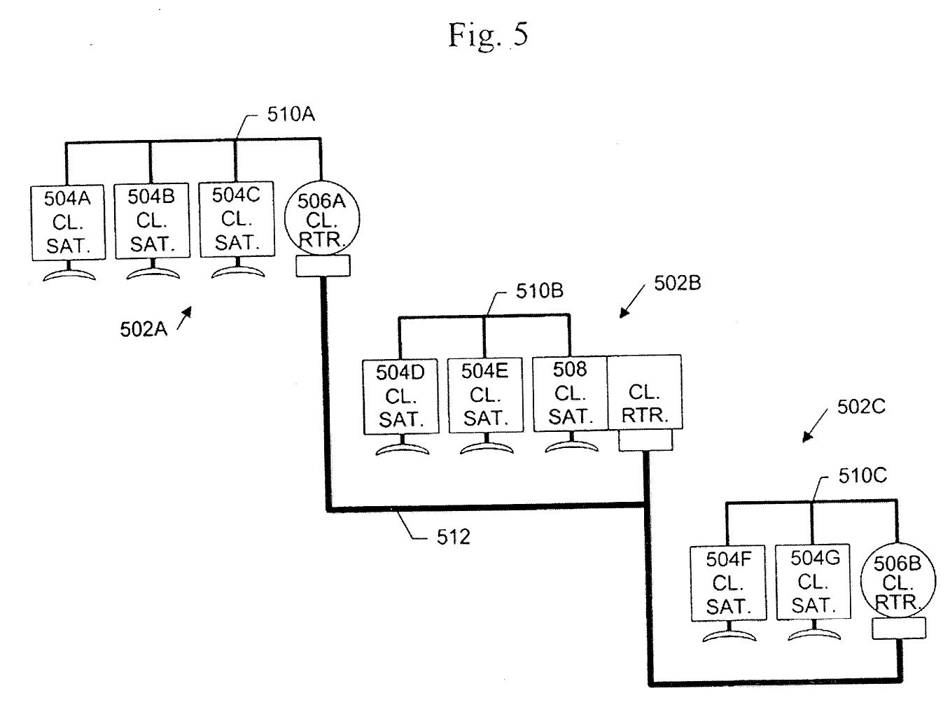

Each geostationary orbital slot only provides communication coverage of a portion of the Earth. In order to provide worldwide communications, several clusters of satellites, each cluster in a different geostationary orbital slot, may be used. An exemplary worldwide geostationary satellite cluster system is shown in FIG. 5. A plurality of satellite clusters, such as clusters 502A, 502B, and 502C are deployed in geostationary orbit, each cluster occupying a different orbital slot. Each cluster includes a plurality of satellites. For example, cluster 502A includes cluster satellites 504A, 504B, and 504C, as well as cluster router 506A. Cluster 502B includes cluster satellites 504D and 504E, as well as cluster satellite/inter-cluster router combination 508. Cluster 502C includes cluster satellites 504F and 504G, as well as cluster router 506B. The satellites in each cluster communicate using an intra cluster local-area network (LAN). For example, the satellites in cluster 502A communicate with each other using intra-cluster LAN 510A. The satellites in cluster 502B communicate with each other using intra-cluster LAN 510B. The satellites in cluster 502C communicate with each other using intra-cluster LAN 510C. Clusters of satellites communicate with each other using inter-cluster wide-area network (WAN) 512.

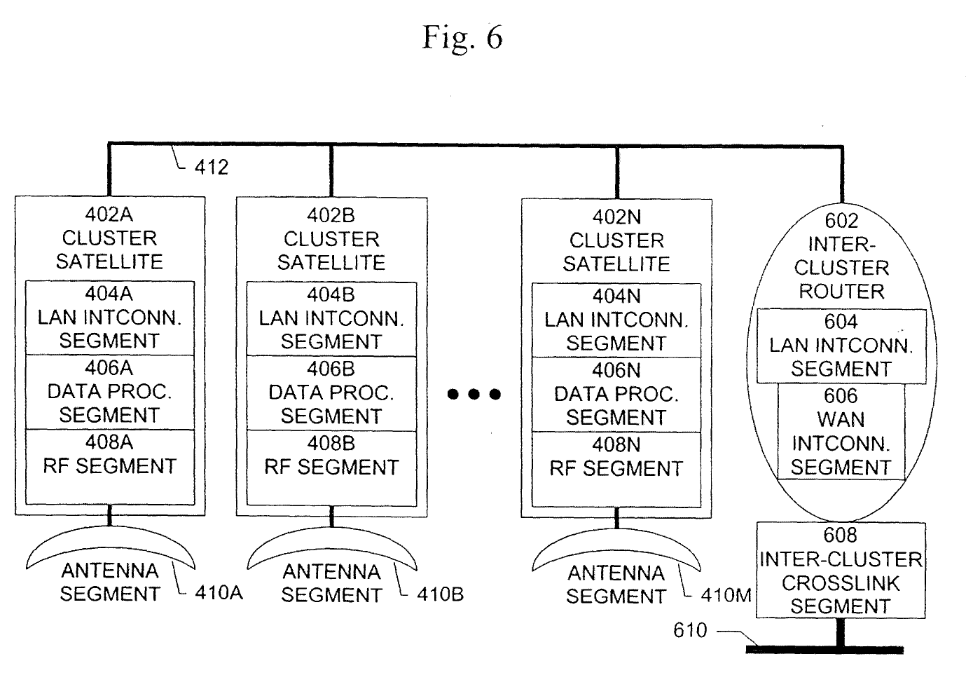

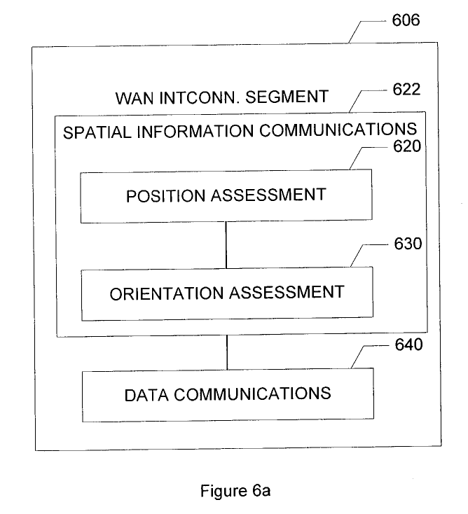

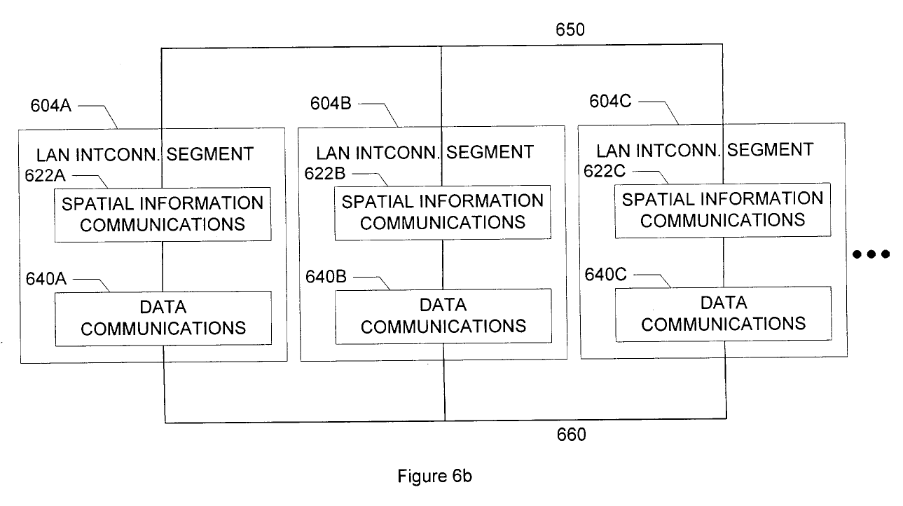

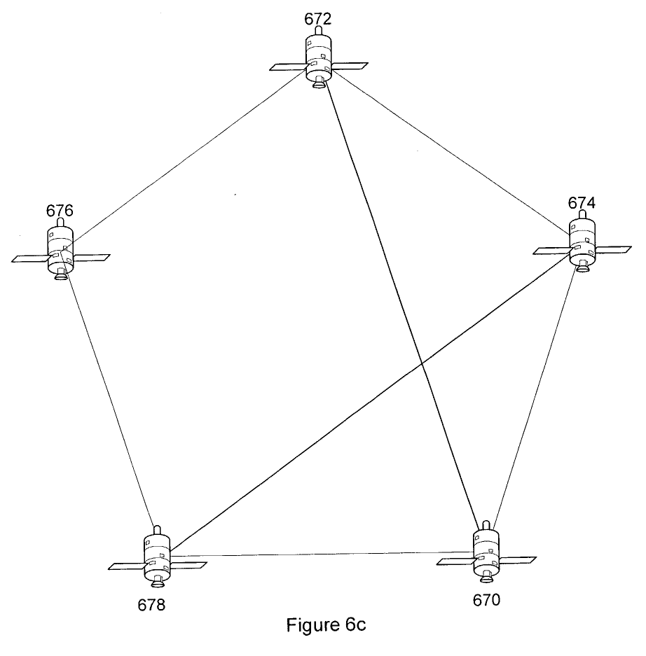

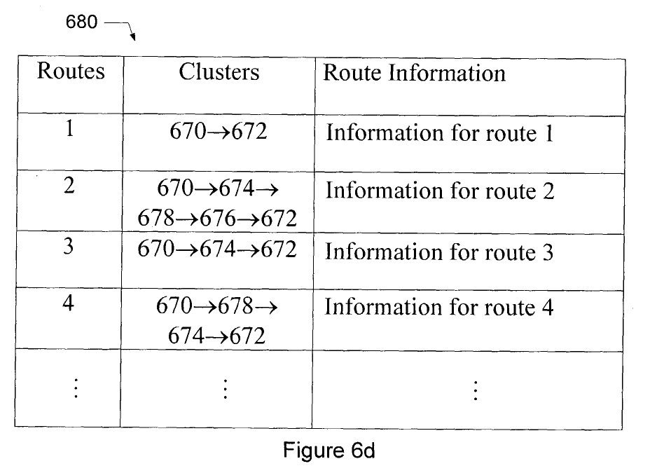

One embodiment of a satellite cluster in which inter-cluster communications are provided is shown in FIG. 6. The satellite cluster shown in FIG. 6 includes cluster satellites 402A-N and inter-cluster router 602. Inter-cluster router 602 includes a LAN interconnect segment 604, a wide-area network (WAN) interconnect segment 606 and an inter-cluster crosslink segment 608. LAN interconnect segment 604 provides inter-cluster router 602 with the functionality to communicate over the intra-cluster LAN 412. WAN interconnect segment 606 provides inter-cluster router 602 with the functionality to communicate over inter-cluster WAN 610. Inter-cluster crosslink segment 608 is the hardware that provides the communication channel over which inter-cluster WAN 610 is carried. In a typical embodiment, the inter-cluster crosslink would be implemented as a laser crosslink, which would have a data bandwidth of about 1 gbps. For redundancy, as well as adequate performance, each inter-cluster router 602 should link to at least two other satellite clusters, if there are two others available.

In embodiment shown in FIG. 6, inter-cluster router 602 is implemented in a satellite separate from cluster satellites 402A-N. This embodiment has the advantage that the entire bandwidth of the inter-cluster router connection to intra-cluster LAN 412 can be devoted to inter-cluster traffic. This embodiment has the disadvantage of the increased expense necessary to procure and launch an extra satellite to implement the inter-cluster router.

The embodiment shown in FIG. 6 may be implemented in either a homogeneous satellite cluster or in a heterogeneous satellite cluster. In a heterogeneous satellite cluster, inter-cluster router 602 may be combined with the cluster utility satellite (not shown in FIG. 6) for the cluster, or inter-cluster router 602 may be separate from the cluster utility satellite. In a homogeneous cluster, no cluster utility satellite is provided and all satellites in the cluster, including the inter-cluster router perform telecommunications traffic routing and relay. In either a homogeneous cluster or a heterogeneous cluster, inter-cluster router 602 may be implemented in a satellite platform similar to those used for cluster satellites 402A-N or in a satellite platform that is different than those used for cluster satellites 402A-N.

Specifically, the LAN interconnect segments 404A, 404B, . . . , 404N and 604 in FIG. 6 are substantially similar to the LAN interconnect segments 404A, 404B, . . . , 404M, and 404N as shown in FIGS. 4, 4a and 4b and as discussed above. The data processing segments 406A, 406B, . . . , and 406N in FIG. 6 are substantially similar to the data processing segments 406A, 406B, . . . , 406M, and 406N as shown in FIGS. 4, 4c and 4d and as discussed above.

As shown in FIG. 6, the inter-cluster WAN 610 includes inter-cluster routers 602 in various clusters. For example, the inter-cluster WAN 512 includes inter-cluster routers 506A, 506B and 506C in clusters 502A, 502B and 502C respectively, as shown in FIG. 5. These inter-cluster routers serve as base stations for the inter-cluster WAN 610 and provide network coverage between the clusters in the space. These inter-cluster routers perform networking functions such as relay, control, and logic functions. The relay function includes receiving, amplifying, and transmitting communication signals, but these inter-cluster routers are more powerful than simply relay satellites. The inter-cluster routers perform control and logic functions, such as switching, routing, channel assignment, and quality of service. The routing process usually involves determination of next network point to which a received communication signal should be forwarded toward its final destination. For instance, the routing process determines the desired route for a given communication signal. For the inter-cluster WAN 610, the next network point is for example an inter-cluster router, and the final destination is for example also an inter-cluster router or a satellite in the same cluster as that of the inter-cluster router. The routing process can also involve determining timing for transmitting a received signal, and delays of the received signal and the transmitted signal.

Moreover, the inter-cluster routers 602 are not only base stations but also users of the inter-cluster WAN 610. These users request information from each other through the inter-cluster WAN 610, and utilize received information to perform various satellite functions, such as transmitting the information to other satellites within the same clusters as the inter-cluster routers 606 respectively.

As shown in FIG. 6, the inter-cluster WAN 610 carries communication signals at various data rates. For example, the data rate can be as high as 1 gbps. Additionally, the inter-cluster WAN 610 includes base stations, i.e., cluster satellites, at various distances. For example, a base station may be from 100 km to 100,000 km away from its nearest base station. Moreover, the inter-cluster routers move with respect to each other. The movement includes change in position, change in orientation, or both, and this movement usually requires that the inter-cluster WAN 610 have navigation capabilities. For example, a base station of the WAN 610, i.e., an inter-cluster router, can seek and obtain spatial information of other base stations. The spatial information includes positions and orientations of other inter-cluster routers with respect to the base station.

FIG. 6a is a simplified diagram for WAN interconnect segment according to an embodiment of the present invention. This diagram is merely an illustration, which should not unduly limit the scope of the claims. One of ordinary skill in the art would recognize many variations, alternatives, and modifications. The WAN interconnect segment 606 is part of the inter-cluster router 602. As shown in FIG. 6a, the WAN interconnect 606 includes a system 622 for spatial information communications and a system 640 for data communications. The system 622 for spatial information communications includes a position assessment system 620 and an orientation assessment system 630. Although the above has been shown using systems 622, 620, 630, and 640, there can be many alternatives, modifications, and variations. For example, some of the systems may be expanded and/or combined. The position assessment system 620 and the orientation assessment system 630 may be combined. Other systems may be inserted to those noted above. Depending upon the embodiment, the specific systems may be replaced. Further details of these systems are found throughout the present specification and more particularly below.

The system 622 for spatial information communications transmits and receives spatial information for the satellite clusters, such as the clusters 502A, 502B and 502C. Also the system 622 sends the obtained spatial information to the system 640 for data communications. More specifically, the position assessment system 620 receives and transmits position information for the inter-cluster routers. Orientation assessment system 630 receives and transmits orientation information for the inter-cluster routers. The obtained position and orientation information can help the system 640 for data communications orientate its transmitter and receiver. The system 640 for data communications in conjunction with the inter-cluster crosslink segment 608 receives and sends communication signals. As discussed above, the inter-cluster router can serve as a base station, a user, or both for the inter-cluster WAN 610.

The navigation capability as embodied in the position assessment system 620 and the orientation assessment system 630 is important for the inter-cluster WAN 610. For example, the inter-cluster WAN 610 has the capability to perform high-speed communications over large distance. Such long-distance communications usually require transmitters with significant transmission power. But high-power transmitters are usually heavy. The satellites however usually have limited energy resources and significant weight limitations. To reduce energy consumption and transmitter weight, the base stations in the inter-cluster WAN 610 usually direct their communication signals to other base stations or user satellites, as opposed to sending out the signals into all directions. The directional transmission usually involves obtaining navigation information and aligning transmitters and receivers. The wireless connection between two inter-cluster routers may take various forms, such as RF connection and optical connection including laser.

FIG. 6b is a simplified diagram showing network structure of WAN according to an embodiment of the present invention. This diagram is merely an illustration, which should not unduly limit the scope of the claims. One of ordinary skill in the art would recognize many variations, alternatives, and modifications. The inter-cluster WAN 512 includes two wireless network, i.e., a wireless network 650 for spatial information communications and a wireless network 660 for data communications. These two wireless networks may operate as a single wireless network or as two separate wireless networks. The wireless networks 650 and 660 are formed respectively between each of the clusters, such as the clusters 502A, 502B, 502C and others as shown in FIG. 5. The wireless network 650 for spatial information communications includes at least a communication channel to transmit and receive spatial information between at least two of the clusters. As shown in FIG. 6b, the wireless network 650 uses systems 622A, 622B, 622C and others for spatial information communications. These systems for spatial information communications are respectively parts of the WAN interconnect segments 606 as described in FIG. 6a. These interconnect segments correspond to the inter-cluster routers 506A, 506B, 506C and others respectively. Each of these inter-cluster routers have spatial information indicative of position and orientation of each of the satellites on which the inter-cluster routers reside respectively. The wireless network 660 for date communications uses systems 640A, 640B, 640C and others for data communications. These systems for data communications are respectively parts of the WAN interconnect segments 606 as shown in FIG. 6a. These interconnect segments correspond to the inter-cluster routers 502A, 502B, 502C, and others respectively. The systems 640A, 640B, 640C, and others for data communications each in conjunction with the respective inter-cluster crosslink segments 608 have a receiver to receive information packets including data and routing information. The routing information provides at least information for a destination cluster as a destination of the data. For example, the routing information is stored in the headers of information packets. The systems 640A, 640B, 640C, and others for data communications each serve as a routing system to determine a desire route from a group of routes to transmit the data from the cluster receiving the information packets to the destination cluster based on at least the spatial information of clusters, such as 512A, 512B, 512C, and others. Each route includes a group of path clusters comprising the receiving cluster and the destination cluster or comprising the receiving cluster, the destination cluster, and at least one of the other clusters of clusters 512A, 512B, 512C, and others. Additionally, these systems for data communications each in conjunction with the respective inter-cluster crosslink segments 608 provide a transmitter to transmit the data based upon the desired route and the spatial information of the path clusters of the desired route. The spatial information of the path satellites of the desired route provides for transferring the data from the receiving cluster to the destination cluster. The receiving cluster, the destination cluster and other path clusters are usually selected from the clusters, such as the clusters 502A, 502B, 502C, and others.

Additionally, the systems 640A, 640B, 640C, and others for data communications receive updated spatial information of clusters 502A, 502B, 502C, and others at a later time step. In response, these systems for data communications determine a updated desired route based on at least the updated spatial information of the clusters. The updated desired route and the pre-update desired route may be the same route or different routes. The transmitters of the systems 640A, 640B, 640C, and others transmit the data based upon the updated desired route and the updated spatial information of the path clusters of the updated desired route. The updated spatial information of the path clusters provides for transferring the data from the receiving cluster to the destination cluster.

FIG. 6c is a simplified diagram for communication routes according to one embodiment of the present invention. This diagram is merely an illustration, which should not unduly limit the scope of the claims. One of ordinary skill in the art would recognize many variations, alternatives, and modifications. Clusters 670, 672, 674, 676 and 678 are examples of clusters 502A, 502B, 502C, and others. For example, the cluster 670 is a receiving cluster that receives a data packet, and the data packet identifies the cluster 672 as its destination cluster. From the cluster 670 to the cluster 672, there exist multiple paths corresponding to different groups of path clusters. For example, a route may take a direct path from the cluster 670 to the cluster 672. Alternatively, a route may take an indirect path from the cluster 670 to the cluster 672. For example, the route passes the clusters 670, 674, 678, 676 and 672, clusters 670, 674, and 672, clusters 670, 678, 674, and 672, or any other group of path clusters.

FIG. 6d is a simplified diagram of inter-cluster routing database for data communications according to one embodiment of the present invention. This diagram is merely an illustration, which should not unduly limit the scope of the claims. One of ordinary skill in the art would recognize many variations, alternatives, and modifications. The systems 640A, 640B, 640C, and others for data communications each have a routing database 680. For example, the routing database 680 for the cluster 670 includes a lists of routes from the cluster 670 to different destinations such as the cluster 672 and other clusters. As illustrated in FIG. 6d, various routes correspond to different groups of path clusters. For instance, route 2 starts from the cluster 670, passes through the cluster 674, 678, and 676, and arrives at the cluster 672. Hence the satellites 670, 674, 678, 676, and 672 are the path clusters for route 2. Additionally, routing database 680 also contains route information corresponding to each route and uses such information to select a desired route.

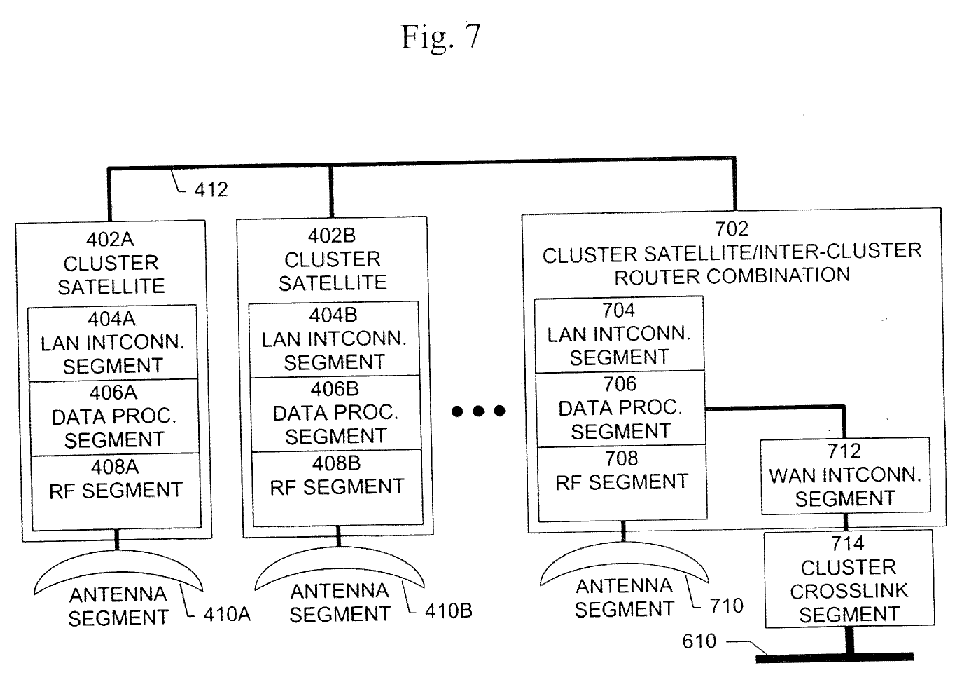

The embodiment shown in FIG. 7 avoids the expense of a separate satellite to implement the inter-cluster router. In this embodiment, the inter-cluster router is integrated with a satellite in the cluster. For example, in FIG. 7, satellite 702 is a cluster satellite/inter-cluster router combination. Satellite 702 includes all the components of a cluster satellite, such as LAN interconnect segment 704, a data processing segment 706, an RF segment 708, and an antenna segment 710. Antenna segment 710 receives communications signals from ground terminals within the antenna's terrestrial coverage zone. RF segment 708 processes the signals received by antenna segment 710 and decodes the signal to provide communications traffic data packets. Data processing segment 706 processes the communications traffic and determines the proper routing for each packet of communications traffic data. LAN interconnect segment 710 provides the satellite with the functionality to communicate over the intra-cluster LAN 412.

Satellite 702 also includes components that implement the inter cluster router functionality, such as LAN interconnect segment 704, wide-area network (WAN) interconnect segment 712 and inter-cluster crosslink segment 714. LAN interconnect segment 702, which is connected to data processing segment 706, provides the functionality to communicate over the intra-cluster LAN 412. Data processing segment 706 processes the communications traffic received from or destined for intra-cluster LAN 412, antenna segment 710/RF segment 708, and inter-cluster WAN 610. Data processing segment 706 determines the proper routing for communications traffic data. If traffic is received from intra-cluster LAN 412 or antenna segment 710/RF segment 708 and is destined for a satellite in another satellite cluster, data processing segment 706 routes the traffic to WAN interconnect segment 712 for transmission over inter-cluster WAN 610. If traffic is received from inter-cluster WAN 610, data processing segment 706 routes the traffic to intra-cluster LAN 412 or antenna segment 710/RF segment 708. WAN interconnect segment 712 provides satellite 702 with the functionality to communicate over inter cluster WAN 610. Inter-cluster crosslink segment 714 is the hardware that provides the communication channel over which inter-cluster WAN 610 is carried.

The embodiment shown in FIG. 7 may be implemented in either a homogeneous satellite cluster or in a heterogeneous satellite cluster. In a heterogeneous satellite cluster, cluster satellite/inter-cluster router combination 702 is provided in addition to a cluster utility satellite (not shown in FIG. 7). In a homogeneous cluster, no cluster utility satellite is provided and all satellites in the cluster, including the cluster satellite/inter-cluster router combination 702 perform telecommunications traffic routing and relay. In either a homogeneous cluster or a heterogeneous cluster, cluster satellite/inter-cluster router combination 702 may be implemented in a satellite platform similar to those used for cluster satellites 402A-N or in a satellite platform that is different than those used for cluster satellites 402A-N.

Specifically, the LAN interconnect segments 404A, 404B, . . . , and 704 in FIG. 7 are substantially similar to the LAN interconnect segments 404A, 404B, . . . , 404M, and 404N as shown in FIGS. 4, 4a and 4b and as discussed above. The data processing segments 406A, 406B, . . . , and 706 in FIG. 7 are substantially similar to the data processing segments 406A, 406B, . . . , 406M, and 406N as shown in FIGS. 4, 4c and 4d and as discussed above. Additionally, the WAN interconnect segment 712 and the inter-cluster crosslink segment 714 in FIG. 7 are substantially similar to the WAN interconnect segment 606 and inter-cluster crosslink segment 608 respectively as shown in FIGS. 6, 6a, 6b, 6c, and 6d and as discussed above.

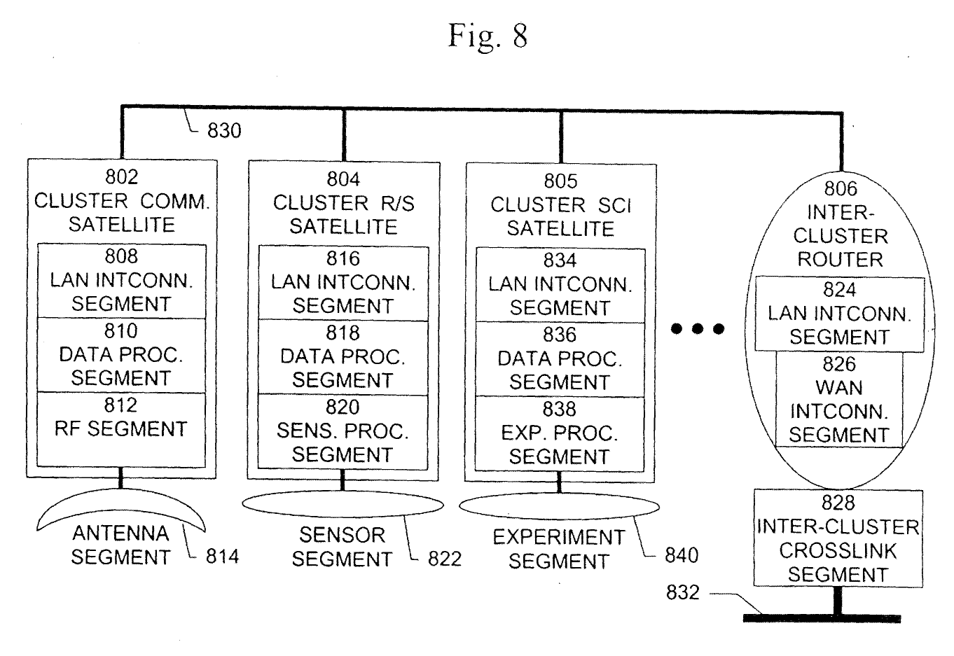

One embodiment of a hybrid satellite cluster, which includes communications satellites, remote sensing satellites, and/or scientific satellites, is shown in FIG. 8. The satellite cluster shown in FIG. 8 may include one or more cluster communication satellites, such as satellite 802, one or more cluster remote sensing satellites, such as satellite 804, one or more scientific satellites, such as satellite 805, and one or more one inter cluster routers, such as router 806. Each cluster communications satellite, such as satellite 802, includes a LAN interconnect segment 808, a data processing segment 810, an RF segment 812, and an antenna segment 814, similar to those already described. Each cluster remote sensing satellite, such as satellite 804, includes a LAN interconnect segment 816, a data processing segment 818, a sensor processing segment 820, and a sensor segment 822. Each cluster scientific satellite, such as satellite 805, includes a LAN interconnect segment 834, a data processing segment 836, an experiment processing segment 838, and an experiment segment 840. Inter cluster router 806 includes a LAN interconnect segment 824, a wide-area network (WAN) interconnect segment 826 and an inter-cluster crosslink segment 828.

Sensor segment 822 of cluster remote sensing satellite 804 senses physical phenomena and outputs signals representing those phenomena. Sensor processing segment 820 processes the signals output by sensor segment 822 and forms sensor data traffic that is to be transmitted to other satellites, other satellite clusters, and/or to ground terminals. Data processing segment 818 processes the sensor data traffic and determines the proper routing for the sensor data traffic. LAN interconnect segment 816 implements a wireless LAN, which provides the satellite with the functionality to communicate over the intra-cluster LAN 830.

Experiment segment 840 of cluster scientific satellite 805 performs one or more scientific experiments and outputs signals representing results of those experiments. Experiment processing segment 840 processes the signals output by experiment segment 838 and forms experiment result data traffic that is to be transmitted to other satellites, other satellite clusters, and/or to ground terminals. Data processing segment 818 processes the experiment result data traffic and determines the proper routing for the experiment result data traffic. LAN interconnect segment 816 implements a wireless LAN, which provides the satellite with the functionality to communicate over the intra-cluster LAN 830.

In embodiment shown in FIG. 8, inter-cluster router 806 is implemented in a satellite separate from the other cluster satellites. This embodiment has the advantage that the entire bandwidth of the inter-cluster router connection to intra-cluster LAN 830 can be devoted to inter-cluster traffic. This embodiment has the disadvantage of the increased expense necessary to procure and launch an extra satellite to implement the inter-cluster router.

The embodiment shown in FIG. 8 may be implemented in either a homogeneous satellite cluster or in a heterogeneous satellite cluster. In a heterogeneous satellite cluster, inter-cluster router 806 may be combined with the cluster utility satellite (not shown in FIG. 8) for the cluster, or inter-cluster router 806 may be separate from the cluster utility satellite. In a homogeneous cluster, no cluster utility satellite is provided and all satellites in the cluster perform their missions, whether communications or remote sensing, without the need for a cluster utility satellite. In either a homogeneous cluster or a heterogeneous cluster, inter-cluster router 806 may be implemented in a satellite platform similar to those used for cluster satellites 802, 804, or 806, or in a satellite platform that is different than those used for cluster satellites 802, 804, or 806.

Specifically, the LAN interconnect segments 808, 816, 834, . . . , and 824 in FIG. 8 are substantially similar to the LAN interconnect segments 404A, 404B, . . . , 404M, and 404N as shown in FIGS. 4, 4a and 4b and as discussed above. The data processing segments 810, 818, 836, and others in FIG. 8 are substantially similar to the data processing segments 406A, 406B, . . . , 406M, and 406N as shown in FIGS. 4, 4c and 4d and as discussed above. Additionally, the WAN interconnect segment 826 and the inter-cluster crosslink segment 828 in FIG. 8 are substantially similar to the WAN interconnect segment 606 and inter-clusier crosslink segment 608 respectively as shown in FIGS. 6, 6a, 6b, 6c, and 6d and as discussed above.

The present invention has many advantages. For example, certain embodiments of the present invention provides a wireless LAN, a wireless WAN, or both. The wireless LAN, the wireless WAN, or both can intelligently route the communication signal through one or several desirable routes towards its final destination. The determination of the desirable routes takes into account various factors, such as route cost, route distance, route availability, route traffic load, and signal priority. For example, a communication signal with high priority takes precedent over a communication signal with low priority. In some embodiments of the present invention, each base station of a wireless LAN, a wireless WAN, or both can route the communication signal to multiple base stations depending upon the routing decision made at a given time for a given communication signal. The communication signal between network base stations and users carries various information, and is not limited to standard messages such as one of time, position, or velocity. Moreover, the wireless network usually directs the communication signal through one or several specific routes, instead of broadcasting the signal to all base stations or users within the network.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A satellite network, the network comprising:
a plurality of satellites disposed in one or a plurality of orbits;
a first wireless network formed between each of the plurality of satellites, the first wireless network comprising a communication channel to transmit and receive spatial information between at least two of the plurality of satellites, each of the plurality of satellites including spatial information indicative of a position and an orientation of the each of the plurality of satellites;
a second wireless network formed between each of the plurality of satellites, the second wireless network comprising
a receiver to receive an information packet including data and routing information at a first satellite, the routing information including at least a destination satellite as a destination of the data;
a routing system to determine a desired route from a plurality of routes to transmit the data from the first satellite to the destination satellite based on at least the spatial information of the plurality of satellites, the plurality of routes corresponding to a plurality of paths respectively, each of the plurality of paths including a plurality of path satellites, each of the plurality of path satellites including the first satellite and the destination satellite or including the first satellite, the destination satellite, and at least one of the other satellites of the plurality of satellites;
a transmitter to transmit the data based upon the desired route and the spatial information of the plurality of path satellites of the desired route, whereupon the spatial information of the plurality of path satellites of the desired route provides for transferring the data from the first satellite to the destination satellite.

2. The satellite network of claim 1, the routing system is further configured to update the spatial information of the plurality of satellites and update the desired route based on at least the updated location information of the plurality of satellites.

3. The satellite network of claim 2, wherein the updated desired route and the pre-update desired route are the same route.

4. The satellite network of claim 2, wherein the updated desired route is different from the pre-update desired route.

5. The satellite network of claim 2, wherein the transmitter is further configured to transmit the data based upon the updated desired route and the updated spatial information of the plurality of path satellites of the updated desired route, whereupon the updated spatial information of the plurality of path satellites of the updated desired route provides for transferring the data from the first satellite to the destination satellite.

6. The satellite network of claim 1, the first wireless network and the second wireless network form a single wireless network.

7. The satellite network of claim 1, wherein the desired route is determined in response to at least one of a priority of the data, a route cost, a route distance, a route availability, and a route traffic load.

8. The satellites network of claim 7, wherein the desired route is determined in response to at least the priority of the data.

9. The satellite network of claim 1, wherein the plurality of satellites serve as a plurality of base stations respectively for the first wireless network and the second wireless network respectively, each of the plurality of the satellites is capable of sending the data to more than one of the plurality of the satellites in response to the desired route.

10. The satellite network of claim 9, wherein the plurality of satellites serve as a plurality of users of the first wireless network and the second wireless network respectively.

11. The satellite network of claim 9, wherein the plurality of base stations move with respect to each other.

12. The satellite network of claim 11, wherein the plurality of base stations move with respect to each other in at least one of position and orientation.

13. The satellite network of claim 12, wherein the plurality of base stations move with respect to each other in orientation by rotation.

14. The satellite network of claim 1, wherein the data are free from a limitation of a standard message.

15. The satellite network of claim 14, wherein the standard message is at least one of time, position, or velocity.

16. The satellite network of claim 1, wherein the second wireless network is free from broadcasting the data to the plurality of satellites.

17. The satellite network of claim 16, wherein the first wireless network is free from broadcasting the spatial information to the plurality of satellites.

18. The satellite network of claim 1, wherein the second wireless network is capable of transmitting and receiving the data at a rate equal to or higher than 1 gigabits per second.

19. The satellite network of claim 18, wherein the second wireless network is capable of transmitting and receiving the communication signal directly between two of the plurality of satellites, the two of the plurality of satellites having a communication distance equal to or larger than 100 kilometers.

20. The satellite network of claim 19, wherein the rate is equal to or higher than 4 gigabits per second.

21. The satellite network of claim 20, wherein the communication distance is equal to or larger than 64 kilometers.

22. The satellite network of claim 21, wherein the communication distance is equal to 200 kilometers.

23. A satellite network, the network comprising:
a plurality of satellites disposed in a single slot of a geostationary orbit;
a wireless local area network formed between each of the plurality of satellites, the wireless local area network comprising:
a communication channel to transmit and receive spatial information between at least two of the plurality of satellites, the spatial information indicative of a position and an orientation of the each of the plurality of satellites;
a receiver to receive a communication signal including data and routing information at a first satellite, the routing information including at least a destination satellite as a destination of the data;
a routing system to determine a desired route from a plurality of routes to transmit the data from the first satellite to the destination satellite, each of the plurality of routes corresponding to a plurality of path satellites, each of the plurality of path satellites including the first satellite and the destination satellite or including the first satellite, the destination satellite, and at least one of the other satellites of the plurality of satellites;
a transmitter to transmit the data based upon the desired route and the spatial information of the plurality of path satellites of the desired route.

24. The satellite network of claim 23, wherein the wireless local area network is capable of transmitting and receiving the communication signal at a data rate equal to or higher than 4 gigabits per second.

25. The satellite network of claim 24, wherein the wireless local network is capable of transmitting and receiving the communication signal directly between two of the plurality of satellites, the two of the plurality of satellites having a communication distance equal to or larger than 64 kilometers.

26. The satellite network of claim 25, wherein the communication distance is equal to 200 kilometers.

27. The satellite network of claim 23, wherein the plurality of satellites comprises a utility satellite and at least one communication satellite;
wherein
the utility satellite receives command data from a ground terminal and transmits the command data to the at least one communications satellite, the utility satellite including a power generator and power distribution circuitry transmitting power to the at least one communications satellite;
the at least one communication satellite includes an antenna operable to receive the communication signal from a ground terminal, radio-frequency receiving circuitry operable to process the communication signal and decode the communication signal to form communications traffic data, and a data processor operable to select another satellite from the plurality of satellites as a destination for the communications traffic data, and local-area network circuitry operable to transmit the communications traffic data to the selected another satellite.

28. The satellite network of claim 23, wherein the plurality of satellites comprises at least one remote sensing satellite, the at least one remote sensing satellite including:
a sensor operable to remotely sense a physical phenomenon and output a signal representing the physical phenomenon;
processing circuitry operable to process the signal output from the sensor to form sensor data;
a data processor operable to select another satellite from the plurality of satellites as a destination for the sensor data; and
local-area network circuitry operable to transmit the sensor data to the selected another satellite.

29. The satellite network system of claim 28, wherein the selected another satellite is operable to transmit the sensor data to a satellite cluster or to a ground terminal, the satellite cluster being free from the plurality of satellites.

30. The satellite network system of claim 23, wherein the plurality of satellites comprises at least one scientific satellite, the at least one scientific satellite including:
an experiment operable to output a signal representing results of a scientific experiment;
processing circuitry operable to process the signal output from the experiment to form result data;
a data processor operable to select another satellite from the plurality of satellites as a destination for the result data; and
local-area network circuitry operable to transmit the result data to a selected satellite of the plurality of satellites.

31. The satellite networking system of claim 30, wherein the selected satellite is operable to transmit the result data to a satellite cluster or to a ground terminal, the satellite cluster being free from the plurality of satellites.

32. A satellite network, the network comprising:
a plurality of satellites clusters, each of the plurality of satellite clusters disposed in a different geostationary orbital slot;
a wireless wide area network formed between each of the plurality of satellite clusters, the wireless wide area network comprising:
a communication channel to transmit and receive spatial information between at least two of the plurality of satellite clusters, the spatial information indicative of a position and an orientation of the each of the plurality of satellite clusters;
a receiver to receive a communication signal including data and routing information at a first satellite cluster, the routing information including at least a destination satellite cluster as a destination of the data;
a routing system to determine a desired route from a plurality of routes to transmit the data from the first satellite cluster to the destination satellite cluster, each of the plurality of routes corresponding to a plurality of path satellite cluster, each of the plurality of path satellite cluster including the first satellite cluster and the destination satellite cluster or including the first satellite cluster, the destination satellite cluster, and at least one of the other satellite cluster of the plurality of satellite cluster;
a transmitter to transmit the data based upon the desired route and the spatial information of the plurality of path satellite clusters of the desired route.

33. The satellite network of claim 32, wherein at least one of the plurality of satellite clusters routes a communication signal through a desired route towards to a final destination of the communication signal.

34. The satellite network system of claim 32, wherein the wireless wide area network is capable of transmitting and receiving the communication signal at a date rate equal to or higher than 1 gigabits per second.

35. The satellite network system of claim 33, wherein the communication distance is equal to or larger than 100 km.

36. The satellite network of claim 32, wherein at least one of the plurality of satellite clusters comprises an inter-cluster router satellite including an inter-cluster router.

37. The satellite network of claim 36, wherein the inter-cluster router satellite is a base station of the wireless wide area network and connected to a wireless local area network of a satellite cluster of the plurality of satellite clusters, the satellite cluster including the inter-cluster router satellite, the wireless local area network free from the inter-cluster router satellite as a base station.

38. The satellite network of claim 36, wherein the inter-cluster router satellite is a base station of the wireless wide area network and a base station of a wireless local area network of a satellite cluster of the plurality of satellite clusters, the satellite cluster including the inter-cluster router satellite.

39. The satellite network of claim 32, wherein the plurality of satellites comprises a utility satellite and at least one communications satellite, the utility satellite operable to receive command data from a ground terminal and transmit the command data to the plurality of satellites, the at least one communications satellite including an antenna operable to receive the communications signal from a ground terminal, radio-frequency receiving circuitry operable to process the communication signal and decode the communication signal to form communications traffic data, a data processor operable to select another satellite from the plurality of satellites as a destination for the communications traffic data, and local-area network circuitry operable to transmit the communications traffic data to the selected another satellite.

40. A method for satellite communication, the method comprising:
disposing a plurality of satellites in one or a plurality of orbits;
transmitting and receiving spatial information between at least two of the plurality of satellites, each of the plurality of satellites including spatial information indicative of a position and an orientation of the each of the plurality of satellites;
receiving an information packet including data and routing information at a first satellite, the routing information including at least a destination satellite as a destination of the data;
determining a desired route from a plurality of routes to transmit the data from the first satellite to the destination satellite based on at least the spatial information of the plurality of satellites, the plurality of routes corresponding to a plurality of paths respectively, each of the plurality of paths including a plurality of path satellites, each of the plurality of path satellites including the first satellite and the destination satellite or including the first satellite, the destination satellite, and at least one of the other satellites of the plurality of satellites;
transmitting the data based upon the desired route and the spatial information of the plurality of path satellites of the desired route, whereupon the spatial information of the plurality of path satellites of the desired route provides for transferring the data from the first satellite to the destination satellite.
